(19) United States
(12) Patent Application Publication
(10) Pub. No.: US 2006/0225473 A1
(43) Pub. Date: Oct. 12, 2006

(54) Reduction of VOC emissions from manure

(76) Inventors: Trisha Marsh Johnson, Athens, GA (US); Michael Christopher O'Brien, Oakdale, CA (US)

Correspondence Address: MACMILLAN SOBANSKI & TODD, LLC, ONE MARITIME PLAZA FIFTH FLOOR, 720 WATER STREET, TOLEDO, OH, 43604-1619, US

(21) Appl. No.: 11/401,557

(22) Filed: Apr. 11, 2006

Related U.S. Application Data
(60) Provisional application No. 60/670,154, filed on Apr. 11, 2005.

(51) Int. Cl. C05F 3/00

(52) U.S. Cl. 71/15; 210/750

(57) ABSTRACT

In a method of reducing emission of VOCs from manure, an acid is applied on the manure to lower the pH of the manure sufficiently to reduce the emission of the VOCs from the manure. Preferably, the VOC emissions are reduced by at least about 20%. The VOC emissions may be reduced by reducing microorganisms that produce VOCs in the manure. In a preferred embodiment, the acid is sodium bisulfate. The invention is applicable in particular to reducing emission of VOCs from cow manure.

### CROSS-REFERENCE TO RELATED APPLICATION

This application claims the benefit of U.S. provisional application Ser. No. 60/670,154 filed on Apr. 11, 2005.

### BACKGROUND OF THE INVENTION

This invention relates in general to emission control methods and in particular to a method of reducing emission of volatile organic compounds (VOCs) from manure such as dairy cow manure.

Dairy cow operations have evolved into densely populated facilities with little land for spreading manure as fertilizer. Manure is scraped up and stockpiled in corrals, where it decomposes and emits large amounts of VOCS. The VOCs combine with nitrogen oxides to form ozone smog. Dairies can generate more than one million tons of manure every year. Emissions from that manure contribute to ozone pollution, which must be reduced to meet federal health-based air quality standards.

The only control technology available at this time is a multi-million dollar anaerobic digester that is not feasible in all operations. Farmers are looking for less capital-intensive and more economical measures for reducing VOC emissions from manure.

### SUMMARY OF THE INVENTION

This invention relates to a method of reducing emission of VOCs from manure. An acid is applied on the manure to lower the pH of the manure sufficiently to reduce the emission of the VOCs from the manure. Preferably, the VOC emissions are reduced by at least about 20%. The VOC emissions may be reduced by reducing microorganisms that produce VOCs in the manure. In a preferred embodiment, the acid is sodium bisulfate. The invention is applicable in particular to reducing emission of VOCs from cow manure.

### DETAILED DESCRIPTION OF THE PREFERRED EMBODIMENT

The invention relates to a method of reducing emission of VOCs from manure. The method involves applying an acid on the manure to lower its pH sufficiently to reduce the emission of VOCs. Preferably, the applied acid lowers the pH of the manure by at least 2 pH units to a pH level below about 5. More preferably, the pH is lowered to a level below about 4, and most preferably below about 3. The pH of the manure can be measured by any suitable method, for example, by taking a sample (e.g., 60 ml) from the surface of the manure, mixing the sample with an equal volume of distilled water to make a slurry, and measuring the pH of the slurry by use of a pH meter.

Any suitable acid can be used to lower the pH of the manure. The term “acid” as used herein includes any pH lowering material. For example, the acid can be any suitable monoprotic or diprotic acid. Some nonlimiting examples of suitable acids may include sodium bisulfate, aluminum sulfate, potassium bisulfate, sulfuric, sulfamic, hydrochloric, phosphoric, citric, propionic, and phosphoric. Other acids that may be suitable include iron salts that produce acid when they hydrolyze, such as ferrous sulfate. Other acids that may be suitable include acids on carrier materials, such as sulfuric acid in clay pieces that leaches out over time.

In some embodiments of the invention, it is preferred to use a dry acid. The acid is applied in the presence of animals, and it may be easier for the animals to tolerate a dry acid than a wet acid. Some examples of dry acids are sodium bisulfate, aluminum sulfate, potassium bisulfate and sulfamic acid. One type of preferred sodium bisulfate is manufactured by Jones-Hamilton Co., Walbridge, Ohio. This sodium bisulfate is described in more detail in U.S. Pat. Nos. 5,707,658; 5,773,063; 5,958,491; and 6,620,445, which are incorporated by reference herein.

In a particular embodiment, the dry acid is not more than mildly irritating to the skin of animals, and preferably is non-irritating to their skin. The effect of a potential chemical irritant on the skin of an animal can be measured by a Primary Irritation Index. Chemicals having a Primary Irritation Index of less than 2 are considered not more than mildly irritating. The method for measuring Primary Irritation Index is described in U.S. Pat. No. 5,707,658.

The acid can be applied on the manure in any manner effective to lower the pH of the manure to reduce the emission of VOCs. This includes application to surfaces which the manure later contacts. For example, the acid can be applied as a cover application on a lot where the animals are located. It can also be applied as a cover application on bedding material, in stalls or other locations. It can also be applied directly to the manure, which can be in the form of excreted manure or in another form such as lagoon manure or a manure slurry. The acid can also be applied to waste water to treat human feces.

As used herein, the term “manure” includes any type of animal or human solid waste, including any type of manure from a ruminant or monogastric organism. Thus, the invention could be applicable not just to cow manure, but also poultry manure, swine manure, horse manure, manure of other animals, and human feces.

The acid can be applied in any suitable amount and frequency. The amount and frequency of application will depend on many factors, such as the type of acid, the number of animals, and the location of the manure. In some embodiments, the acid is applied at a level at least equivalent to 25 lbs/1000 sq ft field application, 50 lbs/1000 sq ft field application, or 75 lbs/1000 sq ft field application.

Also in some embodiments, the acid is applied on a regular basis so that it is available to contact the manure not long after it is excreted by the animals. It is believed that in some embodiments, much of the VOC release occurs within a day or so after manure excretion, so it is desirable to apply acid on a regular basis to have a sufficient supply of acid there to prevent that release. Thus, in some embodiments, the acid is applied at least every second or third day. In other embodiments, the acid can be applied at longer intervals.

While not intending to be limited by theory, it is believed that the VOC emissions are reduced by reducing microorganisms that produce VOCs in the manure. This can include any VOC-producing microorganisms, such as bacteria and/or fungi. Applying acid on the manure to lower its pH is believed to kill and/or inhibit the growth of the microorganisms.

The reduction of VOC emissions in any amount can provide significant benefits. In one embodiment, the VOC emissions are reduced by at least about 20% compared to VOC emissions from the same manure without acid application, and sometimes by at least about 30% or 40%. The VOC emissions can be any VOCs produced by microorganisms in the manure. In one embodiment, the VOC emissions are represented by the emissions of ethanol and methanol from the manure. In a particular example, the emissions of ethanol from the manure may be reduced to a concentration of less than 0.1 ppm, and the emissions of methanol from the manure may be reduced to a concentration of less than 0.2 ppm.

The emissions of VOCs from the manure can be measured by any suitable method. In a particular embodiment, the emissions of ethanol and methanol are measured as follows. The measurements are conducted using three cows and their waste inside an environmental chamber over a period of three days. The environmental chamber (×feet length×y feet height×z feet height, 5,000 cft volume) has a continuous air exchange of 1,320 cfm, which provides a controlled environment (in which both incoming and outgoing air samples will be tested) providing consistent conditions. The environmental chamber has one incoming and one outgoing airduct. Air samples are obtained in the center of the incoming and outgoing airducts immediately above the chamber ceiling. This ensures that the inside chamber conditions remain undisturbed during actual measurements. Atmospheric measurements of the empty chamber on day 1 ensure that background concentrations for the compounds of interest (from chambers themselves) can be determined. Temperature, humidity, and airflow in the chamber are continuously measured and recorded. The environmental chamber houses three lactating Holstein cows. Cows are fed total mixed ration diets, formulated to meet 2001 National Research Council (NRC) nutrient requirements. The emissions of ethanol and methanol from the environmental chamber are analyzed continuously using an INNOVA photoacoustic Field Gas-Monitor (Model 1412; http://www.innova.dk/1412_details.gas_monitoring4.0.html). The instrument is a gas monitoring system based on the photoacoustic infra-red detection method.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

What is claimed is:

1. A method of reducing emission of VOCs from manure comprising applying an acid on the manure to lower the pH of the manure sufficiently to reduce the emission of the VOCs from the manure.

2. The method of claim 1 wherein the VOC emissions are reduced by at least about 20% compared to VOC emissions from the same manure without acid application.

3. The method of claim 1 wherein the VOC emissions are reduced by reducing microorganisms that produce VOCs in the manure.

4. The method of claim 1 wherein the acid is applied at least every third day.

5. The method of claim 1 wherein the applied acid lowers the pH of the manure by at least 2 pH units to a pH level below about 5.

6. The method of claim 1 wherein the acid is applied at a level at least equivalent to 25 lbs/1000 sq ft field application.

7. The method of claim 1 wherein the acid is a dry acid having a Primary Irritation Index of less than about 2.

8. A method of reducing emission of VOCs from manure comprising applying sodium bisulfate on the manure to lower the pH of the manure sufficiently to reduce the emission of the VOCs from the manure.

9. The method of claim 8 wherein the VOC emissions are reduced by at least about 20% compared to VOC emissions from the same manure without acid application.

10. The method of claim 8 wherein the VOC emissions are reduced by reducing microorganisms that produce VOCs in the manure.

11. The method of claim 8 wherein the acid is applied at least every third day.

12. The method of claim 8 wherein the applied acid lowers the pH of the manure by at least 2 pH units to a pH level below about 5.

13. The method of claim 8 wherein the acid is applied at a level at least equivalent to 25 lbs/1000 sq ft field application.

14. The method of claim 8 wherein the acid is a dry acid having a Primary Irritation Index of less than about 2.

15. A method of reducing emission of VOCs from cow manure comprising applying an acid on the manure to lower the pH of the manure sufficiently to reduce the emission of the VOCs from the manure.

16. The method of claim 15 wherein the VOC emissions are reduced by at least about 20% compared to VOC emissions from the same manure without acid application.

17. The method of claim 15 wherein the VOC emissions are reduced by reducing microorganisms that produce VOCs in the manure.

18. The method of claim 15 wherein the acid is applied at least every third day.

19. The method of claim 15 wherein the applied acid lowers the pH of the manure by at least 2 pH units to a pH level below about 5.

20. The method of claim 15 wherein the acid is applied at a level at least equivalent to 25 lbs/1000 sq ft field application.
